(19) United States
(12) Patent Application Publication
(10) Pub. No.: US 2020/0249655 A1
(43) Pub. Date: Aug. 6, 2020

(54) SYSTEM

(71) Applicant: FANUC CORPORATION, Minamitsuru-gun (JP)

(72) Inventors: Yoshiki Satou, Minamitsuru-gun (JP); Toru Kobayashi, Minamitsuru-gun (JP)

(21) Appl. No.: 16/777,674

(22) Filed: Jan. 30, 2020

(30) Foreign Application Priority Data
Feb. 4, 2019 (JP) 2019-017972

(51) Int. Cl. G05B 19/416; G06F 13/20; H05B 47/185

(52) U.S. Cl. CPC G05B 19/416; G06F 13/20; G06F 2213/40; G05B 2219/34013; H05B 47/185

(57) ABSTRACT

A system includes: a first unit including a first lighting section, a first control unit controlling the first lighting section, and a first switch that can toggle between lighting and extinguishing; a second unit including a second lighting section; and a first cable connecting the first unit and the second unit. The first control unit turns on the first lighting section and also turns on the second lighting section via the first cable when the first switch is toggled in a state where the first lighting section is off, and turns off the first lighting section and also turns off the second lighting section via the first cable when the first switch is toggled in a state where the first lighting section is on.

### CROSS-REFERENCE TO RELATED APPLICATION

This application is based upon and claims the benefit of priority from Japanese Patent Application No. 2019-017972 filed on Feb. 4, 2019, the contents of which are incorporated herein by reference.

### BACKGROUND OF THE INVENTION

### Field of the Invention

The present invention relates to a system including a controller and a plurality of devices.

### Description of the Related Art

In a large-scale system including a controller and a plurality of devices as described in Japanese Laid-Open Patent Publication No. 08-215978, the controller and each of the devices may be connected by long distance wiring. In a large-scale system including a machine tool or a press machine, cables are often passed through ducts of the machine, and in a large machine such as a press machine, units are often laid out apart from each other.

### SUMMARY OF THE INVENTION

However, in the large-scale systems as described above, it has been difficult for an operator to quickly confirm that both ends of the wiring are connected in a correct combination. In other words, it has been difficult to investigate if miswiring or incorrect connection occurs.

It is therefore an object of the present invention to provide a system capable of easily confirming that cables are correctly connected.

According to one aspect of the present invention, a system comprises: a first unit including a first lighting section, a first control unit configured to control the first lighting section, and a first switch configured to toggle between lighting and extinguishing; a second unit including a second lighting section; and a first cable connecting the first unit and the second unit. In this system, the first control unit is configured to turn on the first lighting section and also turn on the second lighting section via the first cable when the first switch is toggled in a state where the first lighting section is off, and the first control unit is configured to turn off the first lighting section and also turn off the second lighting section via the first cable when the first switch is toggled in a state where the first lighting section is on.

According to the present invention, it is possible to easily confirm that the cables are correctly connected.

The above and other objects, features, and advantages of the present invention will become more apparent from the following description when taken in conjunction with the accompanying drawings in which a preferred embodiment of the present invention is shown via illustrative example.

### BRIEF DESCRIPTION OF THE DRAWINGS

FIG. 1 is a diagram illustrating a configuration of a system according to an embodiment;

FIG. 2 is a functional block diagram showing part of the configuration of the system; and

FIG. 3 is a diagram for explaining a situation in which incorrect connection due to miswiring occurs in the system of FIG. 1.

### DESCRIPTION OF THE PREFERRED EMBODIMENTS

A preferred embodiment of a system according to the present invention will be described in detail below with reference to the accompanying drawings.

### EMBODIMENT

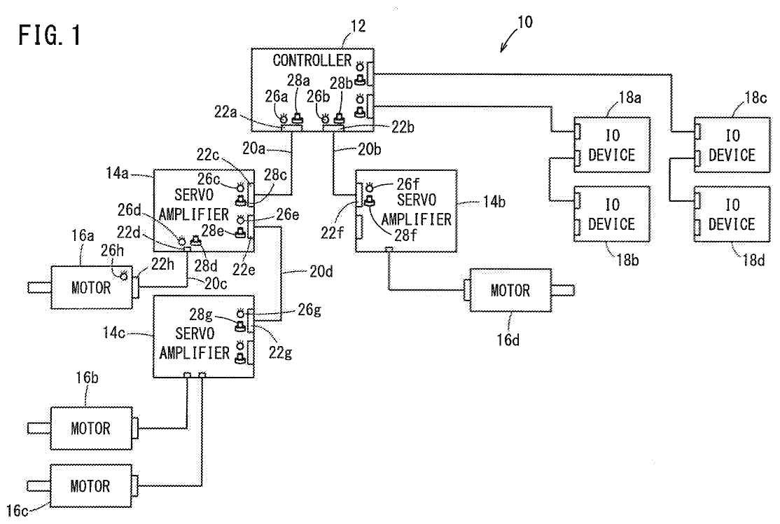

FIG. 1 is a diagram illustrating a configuration of a system 10 according to an embodiment. The system 10 includes a controller 12 and a plurality of devices connected to the controller 12 in a predetermined connection relationship. A specific example of the controller 12 is CNC. The multiple devices connected to the controller 12 are servo amplifiers 14 (14a, 14b, 14c), motors 16 (16a, 16b, 16c, 16d) and IO devices 18 (18a, 18b, 18c, 18d). Each of the controller 12, the servo amplifiers 14, the motors 16 and the IO devices 18 can be regarded as a unit. Each motor 16 is driven by the associated servo amplifier 14. The IO devices 18 are units that perform input/output operations with the outside.

The controller 12 and the servo amplifier 14a are connected by a cable 20a in a predetermined connection relationship. More specifically, the cable 20a connects a connector 22a of the controller 12 and a connector 22c of the servo amplifier 14a. The controller 12 and the servo amplifier 14b (unit) are connected by a cable 20b. More specifically, the cable 20b connects a connector 22b of the controller 12 and a connector 22f of the servo amplifier 14b.

Further, the servo amplifier 14a and the motor 16a are connected by a cable 20c. More specifically, the cable 20c connects a connector 22d of the servo amplifier 14a and a connector 22h of the motor 16a. The servo amplifier 14a and the servo amplifier 14c are connected by a cable 20d. More specifically, the cable 20d connects a connector 22e of the servo amplifier 14a and a connector 22g of the servo amplifier 14c. Thus, the controller 12, the servo amplifier 14a and the servo amplifier 14c are connected in a daisy chain mode.

Further, the controller 12, the IO device 18a and the IO device 18b are also connected in a daisy chain mode, and the controller 12, the IO device 18c and the IO device 18d are also connected in a daisy chain mode. The servo amplifier 14c and the motor 16b, the servo amplifier 14c and the motor 16c, and the servo amplifier 14b and the motor 16d are each connected by wiring.

In FIG. 1, although partially omitted, the connectors 22a to 22g are provided with switches 28a to 28g and lighting sections 26a to 26g, respectively. Note that the motor 16a is provided with a lighting section 26h, but may not be provided with a switch.

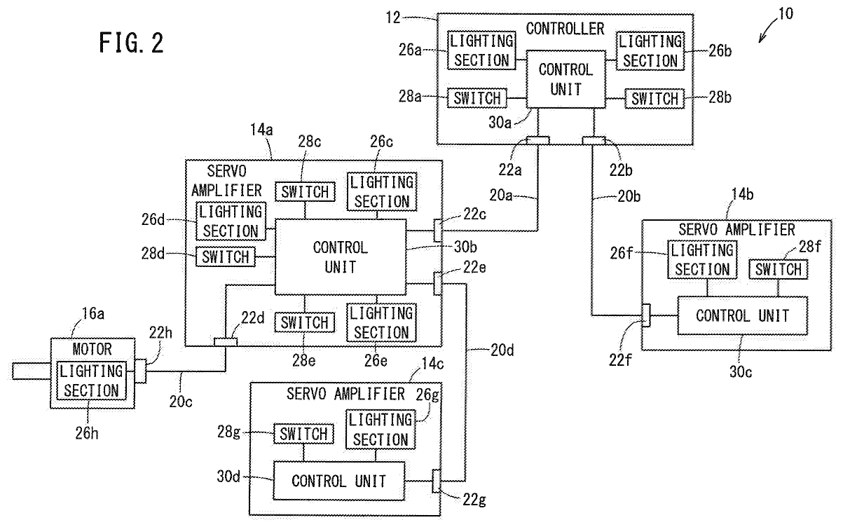

FIG. 2 is a diagram showing part of the configuration of the system 10 with functional blocks. In the configuration of the system 10, those whose operations are not described in the following are omitted.

Now, the configuration of each unit will be described with reference to FIG. 2.

The controller 12 includes the lighting section 26a and the lighting section 26b, the switch 28a and the switch 28b that can each toggle between lighting and extinguishing, and a control unit 30a that controls the lighting section 26a and the lighting section 26b. The cable 20a is connected to the control unit 30a via the connector 22a, and the cable 20b is connected to the control unit 30a via the connector 22b. In the controller 12, the lighting section 26a and the switch 28a are associated with the connector 22a, and the lighting section 26b and the switch 28b are associated with the connector 22b.

The servo amplifier 14a includes the lighting section 26c, the lighting section 26d and the lighting section 26e, the switch 28c, the switch 28d and the switch 28e that can each toggle between lighting and extinguishing, and a control unit 30b that controls the lighting section 26c, the lighting section 26d and the lighting section 26e. The cable 20a is connected to the control unit 30b via the connector 22c, the cable 20c is connected to the control unit 30b via the connector 22d, and the cable 20d is connected to the control unit 30b via the connector 22e. In the servo amplifier 14a, the lighting section 26c and the switch 28c are associated with the connector 22c, the lighting section 26d and the switch 28d are associated with the connector 22d, and the lighting section 26e and the switch 28e are associated with the connector 22e.

The servo amplifier 14b includes the lighting section 26f, the switch 28f that can toggle between lighting and extinguishing, and a control unit 30c that controls the lighting section 26f. The cable 20b is connected to the control unit 30c via the connector 22f. In the servo amplifier 14b, the lighting section 26f and the switch 28f are associated with the connector 22f.

The servo amplifier 14c includes the lighting section 26g, the switch 28g that can toggle between lighting and extinguishing, and a control unit 30d that controls the lighting section 26g. The cable 20d is connected to the control unit 30d via the connector 22g. In the servo amplifier 14c, the lighting section 26g and the switch 28g are associated with the connector 22g.

The motor 16a includes the lighting section 26h. The cable 20c is a power line and is connected to the lighting section 26h and an unillustrated motor body. In the motor 16a, the lighting section 26h is associated with the connector 22h.

The following describes the control and operation of each unit.

In the controller 12, when the switch 28a is toggled in a state where the lighting section 26a is off, the control unit 30a turns on the lighting section 26a and transmits a turn-on command via the cable 20a. The turn-on command is a control signal that instructs to turn on the lighting sections. When the switch 28a is toggled in a state where the lighting section 26a is on, the control unit 30a turns off the lighting section 26a and transmits a turn-off command via the cable 20a. The turn-off command is a control signal that instructs to turn off the lighting sections. On the other hand, when receiving a turn-off command via the cable 20a in a state where the lighting section 26a is on, the control unit 30a turns off the lighting section 26a. Further, when receiving a turn-on command via the cable 20a in a state where the lighting section 26a is off, the control unit 30a turns on the lighting section 26a.

In addition, when the switch 28b is toggled in a state where the lighting section 26b is off, the control unit 30a turns on the lighting section 26b and transmits a turn-on command via the cable 20b. When the switch 28b is toggled in a state where the lighting section 26b is on, the control unit 30a turns off the lighting section 26b and transmits a turn-off command via the cable 20b. On the other hand, when receiving a turn-off command via the cable 20b in a state where the lighting section 26b is on, the control unit 30a turns off the lighting section 26b. Further, when receiving a turn-on command via the cable 20b in a state where the lighting section 26b is off, the control unit 30a turns on the lighting section 26b.

In the servo amplifier 14a, when the switch 28c is toggled in a state where the lighting section 26c is off, the control unit 30b turns on the lighting section 26c and transmits a turn-on command via the cable 20a. When the switch 28c is toggled in a state where the lighting section 26c is on, the control unit 30b turns off the lighting section 26c and transmits a turn-off command via the cable 20a. On the other hand, when receiving a turn-off command via the cable 20a in a state where the lighting section 26c is on, the control unit 30b turns off the lighting section 26c. Further, when receiving a turn-on command via the cable 20a in a state where the lighting section 26c is off, the control unit 30b turns on the lighting section 26c.

In addition, when the switch 28e is toggled in a state where the lighting section 26e is off, the control unit 30b turns on the lighting section 26e and transmits a turn-on command via the cable 20d. When the switch 28e is toggled in a state where the lighting section 26e is on, the control unit 30b turns off the lighting section 26e and transmits a turn-off command via the cable 20d. On the other hand, when receiving a turn-off command via the cable 20d in a state where the lighting section 26e is on, the control unit 30b turns off the lighting section 26e. Further, when receiving a turn-on command via the cable 20d in a state where the lighting section 26e is off, the control unit 30b turns on the lighting section 26e.

When the switch 28d is toggled in a state where the lighting section 26d is off, the control unit 30b turns on the lighting section 26d and supplies power through the cable 20c, which is the power line. Here, the power supplied by the control unit 30b via the cable 20c is power for driving the motor 16a. When the switch 28d is toggled in a state where the lighting section 26d is on, the control unit 30b turns off the lighting section 26d and stops supplying power through the cable 20c.

In the servo amplifier 14b, when the switch 28f is toggled in a state where the lighting section 26f is off, the control unit 30c turns on the lighting section 26f and transmits a turn-on command via the cable 20b. When the switch 28f is toggled in a state where the lighting section 26f is on, the control unit 30c turns off the lighting section 26f and transmits a turn-off command via the cable 20b. On the other hand, when receiving a turn-off command via the cable 20b in a state where the lighting section 26f is on, the control unit 30c turns off the lighting section 26f. Further, when receiving a turn-on command via the cable 20b in a state where the lighting section 26f is off, the control unit 30c turns on the lighting section 26f.

In the servo amplifier 14c, when the switch 28g is toggled in a state where the lighting section 26g is off, the control unit 30d turns on the lighting section 26g and transmits a turn-on command via the cable 20d. When the switch 28g is toggled in a state where the lighting section 26g is on, the control unit 30d turns off the lighting section 26g and transmits a turn-off command via the cable 20d. On the other hand, when receiving a turn-off command via the cable 20d in a state where the lighting section 26g is on, the control unit 30d turns off the lighting section 26g. Further, when receiving a turn-on command via the cable 20d in a state where the lighting section 26g is off, the control unit 30d turns on the lighting section 26g.

In the motor 16a, when power for driving the motor 16a is supplied via the cable 20c in a state where the lighting section 26h is off, the power via the cable 20c is supplied to the motor body and the lighting section 26h so that the lighting section 26h is turned on by the supplied power. When power supply via the cable 20c is stopped in a state where the lighting section 26h is on, the lighting section 26h is turned off.

The following describes the operations of the system 10 when the operator checks whether or not the cables are correctly connected in the system 10 in the case where miswiring occurs and in the case where miswiring does not occur.

First, description will be made on the operation of the system 10 when the cable 20a for connecting the controller 12 (first unit) and the servo amplifier 14a (second unit) is correctly connected between the connector 22a and the connector 22c as shown in FIG. 1.

When an operator who can operate the controller 12 toggles the switch 28a in a state where the lighting section 26a is off, the control unit 30a turns on the lighting section 26a while the control unit 30b having received the turn-on command transmitted from the control unit 30a via the cable 20a turns on the lighting section 26c. To the contrary, when the operator toggles the switch 28a in a state where the lighting section 26a is on, the control unit 30a turns off the lighting section 26a and the control unit 30b having received the turn-off command transmitted from the control unit 30a via the cable 20a turns off the lighting section 26c. That is, a toggling operation on the switch 28a turns both the lighting section 26a and the lighting section 26c on or off, so that the operator can easily and visually confirm that the cable 20a is correctly connected.

After confirmation that the cable 20a is correctly connected as described above, both of the lighting section 26a and the lighting section 26c are either in the on state or in the off state. Therefore, when an operator who can operate the servo amplifier 14a toggles the switch 28c in the state where both of the lighting sections are on, the control unit 30b turns off the lighting section 26c. At the same time, as the switch 28c is toggled, the control unit 30a having received the turn-off command transmitted from the control unit 30b via the cable 20a turns off the lighting section 26a. On the other hand, when the operator toggles the switch 28c in the state where both of the lighting sections are off, the control unit 30b turns on the lighting section 26c, and at the same time the control unit 30a having received the turn-on command transmitted from the control unit 30b via the cable 20a turns on the lighting section 26a. In this way, the operator can reset the checking work of the connection of the cable 20a.

Also, when the cable 20b for connecting the controller 12 (first unit) and the servo amplifier 14b (third unit) is correctly connected between the connector 22b and the connector 22f as shown in FIG. 1, the checking work and the resetting work of the cable 20b are the same as those described above for the cable 20a that connects the controller 12 and the servo amplifier 14a. Further, when the cable 20d for connecting the servo amplifier 14a and the servo amplifier 14c is correctly connected between the connector 22e and the connector 22g as shown in FIG. 1, the checking work and the resetting work of the cable 20d are also the same as those described above for the cable 20a that connects the controller 12 and the servo amplifier 14a.

That is, in the system 10, the switch and the lighting section are provided for each connector of each unit, and therefore the checking work and resetting work can be performed for each cable that connects two units.

Next, a case of checking the connection of the motor 16 will be described separately because the motor 16 does not include any switch or control unit. The following describes the operation of the system 10 when the cable 20c for connecting the servo amplifier 14a (first unit) and the motor 16a (second unit) is correctly connected between the connector 22d and the connector 22h as shown in FIG. 1.

When an operator who can operate the servo amplifier 14a toggles the switch 28d to lighting, the control unit 30b turns on the lighting section 26d and also supplies power for driving the motor 16a to the motor 16a via the cable 20c. The power from the cable 20c is supplied to the motor body and the lighting section 26h so that the lighting section 26h is turned on by the supplied power. Then, when the switch 28d is toggled to extinguishing in the state where the lighting section 26h is on, the control unit 30b turns off the lighting section 26d and stops supplying power via the cable 20c, so that the lighting section 26h is turned off. That is, a toggling operation on the switch 28d turns both the lighting section 26d and the lighting section 26h on or off. As a result, even if the motor 16a is installed distant from the servo amplifier 14a, it is possible for the operator to easily and visually confirm that the cable 20c is correctly connected.

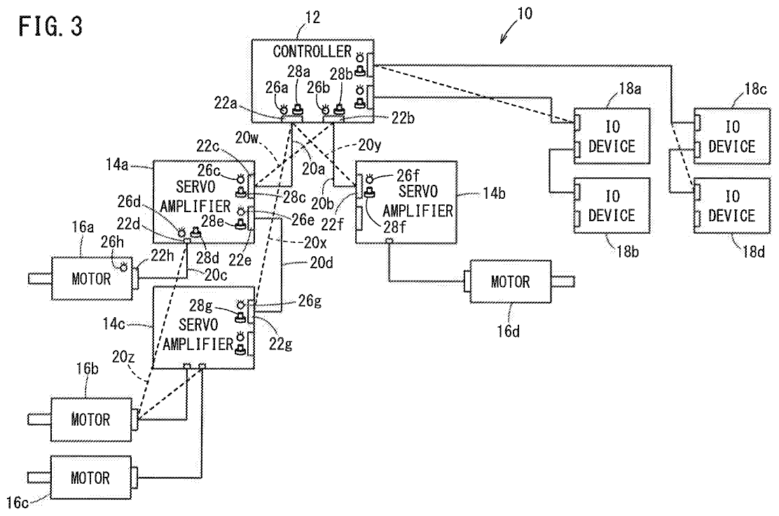

Now, description will be made on the operation when incorrect connection takes place due to miswiring in the system 10 of FIG. 1. FIG. 3 is a diagram illustrating a situation in which incorrect connection due to miswiring occurs in the system 10 of FIG. 1. The broken lines in FIG. 3 indicate cables that are miswired in the system 10.

In the checking work of connection between the controller 12 and the servo amplifier 14a by the cable 20a, in a case where the cable 20a is miswired as indicated by a cable 20x or a cable 20y, when the operator toggles the switch 28a, the lighting section 26a turns on or off in response to the toggling of the switch 28a. However, the lighting section 26c does not react to the toggling of the switch 28a and remains off or on. Additionally, when the cable is miswired as indicated by the cable 20x, the lighting section 26g turns on or off in response to the toggling of the switch 28a, and when the cable is miswired as indicated by the cable 20y, the lighting section 26f turns on or off in response to the toggling of the switch 28a.

As a result, even if the servo amplifier 14a is installed distant from the controller 12, the operator who is near the controller 12 can easily confirm incorrect connection of the cable 20a due to miswiring only by visually checking the state of the lighting section 26c when the switch 28a is operated. At the same time, by visually checking which of the lighting sections 26g and 26f turns on or off in response to the toggling of the switch 28a, the operator can determine whether the cable 20a is miswired as in the case of the cable 20x or the cable 20y. That is, it is possible to grasp the end of the incorrect connection.

Further, in the checking work of connection between the controller 12 and the servo amplifier 14b by the cable 20b, in a case where the cable 20b is miswired as indicated by a cable 20w, when the operator toggles the switch 28b, the lighting section 26b turns on or off in response to the toggling of the switch 28b. However, the lighting section 26f does not react to the toggling of the switch 28b and remains off or on. Instead, the lighting section 26c turns on or off in response to the toggling of the switch 28b. In this way, the operator can visually confirm that the cable 20b is miswired as indicated by the cable 20w.

Therefore, even if the servo amplifiers 14a and 14b are installed distant from the controller 12, when the cables 20a and 20b are miswired in such a manner that the connection of the cable 20a and the connection of the cable 20b are switched with each other as indicated by the cables 20y and 20w, the lighting section 26f turns on or off in response to the toggling of the switch 28a, and the lighting section 26c turns on or off in response to the toggling of the switch 28b. As a result, even if the cables are miswired in such a manner that the connections of the cables are switched with each other and the servo amplifiers 14a and 14b are thereby incorrectly connected to the controller 12, the operator near the controller 12 can easily and visually confirm miswiring and the ends of the incorrect connections.

Further, in the checking work of connection between the servo amplifier 14a and the motor 16a by the cable 20c, in a case where the cable 20c is miswired as indicated by a cable 20z, power for driving the motor 16a is not supplied from the servo amplifier 14a to drive the motor 16a. Accordingly, when an operator who can operate the servo amplifier 14a toggles the switch 28d, the lighting section 26d turns on or off, but the lighting section 26h remains off because power is not supplied thereto. In this case, if a lighting section (not shown) similar to the lighting section 26h is provided for the motor 16b to which the miswired cable 20z is connected, the operator can visually observe that this lighting section turns on or off so as to confirm that the end of the incorrect connection is the motor 16b.

Moreover, although not shown in the figures, the IO devices 18 (18a, 18b, 18c, 18d) each have a control unit, and a switch and a light for each connector. Accordingly, it is possible to perform the connection checking work and resetting work for each cable that connects the controller 12 and the IO device 18 or connects the two IO devices 18.

### Invention Obtained from the Embodiment

The invention that can be grasped from the above embodiment will be described below.

A system (10) comprises: a first unit (12) including a first lighting section (26a), a first control unit (30a) configured to control the first lighting section (26a) and a first switch (28a) configured to toggle between lighting and extinguishing; a second unit (14a) including a second lighting section (26c); and a first cable (20a) connecting the first unit (12) and the second unit (14a). The first control unit (30a) is configured to turn on the first lighting section (26a) and also turn on the second lighting section (26c) via the first cable (20a) when the first switch (28a) is toggled in a state where the first lighting section (26a) is off, and is configured to turn off the first lighting section (26a) and also turn off the second lighting section (26c) via the first cable (20a) when the first switch (28a) is toggled in a state where the first lighting section (26a) is on.

This allows the operator to easily confirm that the cable is correctly connected.

The second unit (14a) may further include a second control unit (30b) configured to control the second lighting section (26c), and a second switch (28c) configured to toggle between lighting and extinguishing. The second control unit (30b) may be configured to turn off the second lighting section (26c) and also turn off the first lighting section (26a) via the first cable (20a) when the second switch (28c) is toggled in a state where the second lighting section (26c) is on. This makes it possible to reset the checking work of cable connection.

The second unit (14a) may further include a second control unit (30b) configured to control the second lighting section (26c), and a second switch (28c) configured to toggle between lighting and extinguishing. The second control unit (30b) may be configured to turn on the second lighting section (26c) and also turn on the first lighting section (26a) via the first cable (20a) when the second switch (28c) is toggled in a state where the second lighting section (26c) is off. This makes it possible to reset the checking work of cable connection.

The system (10) may further comprises a third unit (14b) including a third lighting section (26f) and a second cable (20b) connecting the first unit (12) and the third unit (14b). The first unit (12) may further include a fourth lighting section (26b), and a third switch (28b) configured to toggle between lighting and extinguishing. The first control unit (30a) may be configured to turn on the fourth lighting section (26b) and also turn on the third lighting section (26f) via the second cable (20b) when the third switch (28b) is toggled in a state where the fourth lighting section (26b) is off, and configured to turn off the fourth lighting section (26b) and also turn off the third lighting section (26f) via the second cable (20b) when the third switch (28b) is toggled in a state where the fourth lighting section (26b) is on. With this configuration, even if the cables are miswired in such a manner that the connections of the cables are switched with each other and the servo amplifiers (14a, 14b) are thereby incorrectly connected to the controller (12), it is possible to easily confirm the miswiring and the ends of the incorrect connections.

The system (10) may be a system that includes a controller (12) and a plurality of devices connected to the controller (12) in a predetermined connection relationship, and each of the first unit and the second unit may be either the controller (12) or the device.

The plurality of devices may include at least one of a servo amplifier (14a, 14b, 14c), an IO device (18a, 18b, 18c, 18d) and a motor (16a, 16b, 16c, 16d).

The first unit may be a servo amplifier (14a), the second unit may be a motor (16a) and the first cable (20c) may be a power line. The first control unit (30b) may be configured to turn on the second lighting section (26h) by supplying power for driving the motor (16a) to the second lighting section (26h) via the first cable (20c) when the first switch (28d) is toggled to lighting. As a result, the operator near the servo amplifier (14a) can easily confirm that the cable (20c) is correctly connected even if the motor (16a) is installed distant from the servo amplifier (14a).

What is claimed is:

1. A system comprising:
a first unit including a first lighting section, a first control unit configured to control the first lighting section, and a first switch configured to toggle between lighting and extinguishing;
a second unit including a second lighting section; and
a first cable connecting the first unit and the second unit, wherein:
the first control unit is configured to turn on the first lighting section and also turn on the second lighting section via the first cable when the first switch is toggled in a state where the first lighting section is off; and
the first control unit is configured to turn off the first lighting section and also turn off the second lighting section via the first cable when the first switch is toggled in a state where the first lighting section is on.

2. The system according to claim 1, wherein:
the second unit further includes a second control unit configured to control the second lighting section, and a second switch configured to toggle between lighting and extinguishing; and
the second control unit is configured to turn off the second lighting section and also turn off the first lighting section via the first cable when the second switch is toggled in a state where the second lighting section is on.

3. The system according to claim 1, wherein:
the second unit further includes a second control unit configured to control the second lighting section, and a second switch configured to toggle between lighting and extinguishing; and
the second control unit is configured to turn on the second lighting section and also turn on the first lighting section via the first cable when the second switch is toggled in a state where the second lighting section is off.

4. The system according to claim 1, further comprising:
a third unit including a third lighting section; and
a second cable connecting the first unit and the third unit, wherein:
the first unit further includes a fourth lighting section, and a third switch configured to toggle between lighting and extinguishing;
the first control unit is configured to turn on the fourth lighting section and also turn on the third lighting section via the second cable when the third switch is toggled in a state where the fourth lighting section is off; and
the first control unit is configured to turn off the fourth lighting section and also turn off the third lighting section via the second cable when the third switch is toggled in a state where the fourth lighting section is on.

5. The system according to claim 1, wherein:
the system is a system that includes a controller and a plurality of devices connected to the controller in a predetermined connection relationship; and
each of the first unit and the second unit is either the controller or the device.

6. The system according to claim 5, wherein the plurality of devices include at least one of a servo amplifier, an IO device and a motor.

7. The system according to claim 1, wherein:
the first unit is a servo amplifier, the second unit is a motor, and the first cable is a power line; and
the first control unit is configured to turn on the second lighting section by supplying power for driving the motor to the second lighting section via the first cable when the first switch is toggled to lighting.
